(19) United States
(12) Patent Application Publication
(10) Pub. No.: US 2004/0258959 A1
(43) Pub. Date: Dec. 23, 2004

(54) Magnetic recording medium and method of forming thereof, and underlayer structure thereof

(75) Inventors: Yoshiharu Kashiwakura, Nagano (JP); Yoshifumi Ajishi, Nagano (JP); Tetsu Ikegami, Nagano (JP)

Correspondence Address: ROSSI & ASSOCIATES, P.O. BOX 826, ASHBURN, VA, 20146-0826, US

(73) Assignee: Fuji Electric Device Technology, Co., Ltd.

(21) Appl. No.: 10/766,535

(22) Filed: Jan. 28, 2004

(30) Foreign Application Priority Data
Jan. 28, 2003 (JP) 2003-019263

(51) Int. Cl. B32B 3/02

(52) U.S. Cl. 428/694 T; 428/65.3; 428/694 TS

(57) ABSTRACT

A magnetic recording medium has a novel underlayer structure that with reduced crystal grain size and good crystallinity to increase SNR and improve recording density. The underlayer structure includes a first underlayer, a Cr—Mn layer, and a second underlayer. The underlayer structure is formed over a nonmagnetic substrate. A magnetic recording layer composed of a Co alloy and a carbon protective layer are formed in this order on the underlayer structure. The underlayer structure, magnetic recording layer, and the protective layer can be formed in this order by DC magnetron sputtering on the substrate, which can be composed of an aluminum alloy having thereon an Ni—P plating layer that has been textured in a circumferential direction. The Cr—Mn layer have an Mn content of not more than 20 at % and a thickness ranging 0.5 nm to 3 nm, or an Mn content of not more than 30 at % and a thickness ranging 0.5 nm to 2.5 nm.

### BACKGROUND

In recent years, advances have been made to increase the recording density of storage devices for information apparatuses, such as computers. In the case of magnetic recording devices, the recording density has been increased by improving both the magnetic heads that read/write the information and the magnetic recording media from/to which the information is read/written. To increase the recording density of a magnetic recording medium, it is necessary to increase the SNR, which is the ratio of the readback signal (when reading/writing an information signal) to the medium noise. In general, a magnetic recording medium has a layered structure comprising a plurality of thin films.

FIG. 1 schematically illustrates the layer structure of a conventional magnetic recording medium, which comprises a nonmagnetic substrate 1, a nonmagnetic underlayer 2, a magnetic recording layer 3, and a protective layer 4. Such a conventional magnetic recording medium is manufactured by forming the nonmagnetic underlayer 2 (hereinafter referred to as the ‘underlayer’), which is for controlling crystal orientation, the magnetic recording layer 3 to which information can be written, and the protective layer 4, which is for protecting the magnetic recording layer 3 when a magnetic head slides over the magnetic recording medium, in this order on the nonmagnetic substrate 1, which is made of an aluminum alloy, a glass or the like.

There is crystalline continuity from the underlayer 2, which contacts the nonmagnetic substrate 1, to the magnetic recording layer 3, which is furthest from the nonmagnetic substrate 1. In general, the underlayer is composed of an intermetallic compound, such as NiAI or a metallic thin film of Cr or a Cr alloy having a bcc structure, the magnetic recording layer 3 is composed of a magnetic thin film consisting primarily of an alloy of Co and Cr having several other elements added thereto, and the protective layer 4 is composed of a thin film consisting primarily of carbon. In general, sputtering or CVD is used as the method of forming the films, since in this case control of the thin film properties is easy, and thin films of high quality can be obtained.

The underlayer 2 and the magnetic recording layer 3 include an aggregate of minute metallic crystal grains. To increase the SNR, and thus improve the recording density, it is necessary to control the crystal structure of the magnetic recording layer 3. Specifically, a crystal structure that is orientated in a prescribed direction and having few defects is preferable. The crystal structure of the underlayer 2 initially formed on the nonmagnetic substrate I has an important role in determining the crystal structure of the magnetic recording layer 3.

Controlling the grain size and crystal orientation of the underlayer 2 is thus essential for improving the recording density of a magnetic recording medium. For example, to improve the crystal lattice conformity with the magnetic recording layer 3, a suitable alloy composition is selected for the underlayer 2. Methods such as laminating together a underlayer having good orientation and a underlayer having good crystal lattice conformity have been adopted. See for example Japanese Patent Application Laid-open No. 2001-312814 and Japanese Patent Application Laid-open No. 10-241937. Moreover, to reduce the crystal grain size in the underlayer, it is effective, for example, to increase the gas pressure during the film formation and to reduce the thickness of the underlayer so that the crystal grain size is not enlarged, and these means have been adopted from hitherto.

As described above, to further increase recording density, the crystal control of the underlayer is essential. However, with the conventional methods, it is difficult to achieve both improvement of the crystal growth and crystal orientation and reduction of the grain size. For example, if the thickness of the underlayer is reduced excessively, then the crystal grain size will be reduced, but a problem will arise in that crystal growth will be insufficient and hence the crystal orientation will deteriorate. Moreover, the crystallinity can be increased by selecting the composition or material system, but to reduce the grain size at the same time, it is still necessary to use this in combination with a technique that sacrifices the crystallinity, such as reducing the film thickness.

In view of the problems described above, there still remains a need for an underlayer structure to provide a magnetic recording medium having reduced crystal grain size and good crystallinity, which increase the SNR, and hence improving the recording density. The present invention addresses this need.

### SUMMARY OF THE INVENTION

The present invention relates to a magnetic recording medium, an underlayer structure thereof, and a method of forming the medium.

One aspect of the present invention is a magnetic recording medium that includes a nonmagnetic substrate, an underlayer structure on the substrate, and a magnetic recording layer on the underlayer structure. The magnetic recording layer can be composed of a Co alloy. The underlayer structure comprises a combination of at least two nonmagnetic underlayers each composed of a material selected from pure metals and alloys having a bcc structure, and a Cr—Mn alloy thin film provided between the two nonmagnetic underlayers.

The nonmagnetic underlayers each can be made of pure Cr or a Cr alloy. The Cr—Mn alloy thin film can have an Mn content of not more than 20 at % and a thickness ranging 0.5 nm to 3 nm. The Cr—Mn alloy thin film can have an Mn content of not more than 30 at % and a thickness ranging 0.5 nm to 3 nm. One of the two underlayers can be composed of pure Cr and the other of the two underlayers can be composed of an alloy of Cr and at least one element selected from Mo, W, V, Ti, B and Ta. The other of the two underlayers can be composed of an alloy of Cr and Mo.

The nonmagnetic substrate can be composed of an aluminum alloy having thereon an Ni—P plating layer, which can have a texture with an average roughness of 0.5 nm in a circumferential direction of the substrate. The magnetic recording medium further includes a protective layer on the magnetic recording layer.

Another aspect of the present invention is the novel underlayer structure for a magnetic recording medium described above.

Another aspect of the present invention is a method of forming the magnetic recording medium described above. The method can include providing the nonmagnetic substrate, forming the underlayer structure on the substrate, and forming the magnetic recording layer on the underlayer structure. It further includes forming the protective layer on the magnetic recording layer.

The underlayer structure, the magnetic recording layer, and the protective layer can be formed by sputtering under an argon atmosphere of 5 mTorr. The substrate is heated to 250° C. before sputtering the underlayer structure, the magnetic recording layer, and the protective layer on the substrate.

### BRIEF DESCRIPTION OF THE DRAWINGS

FIG. 1 schematically illustrates the layer structure of a conventional magnetic recording medium.

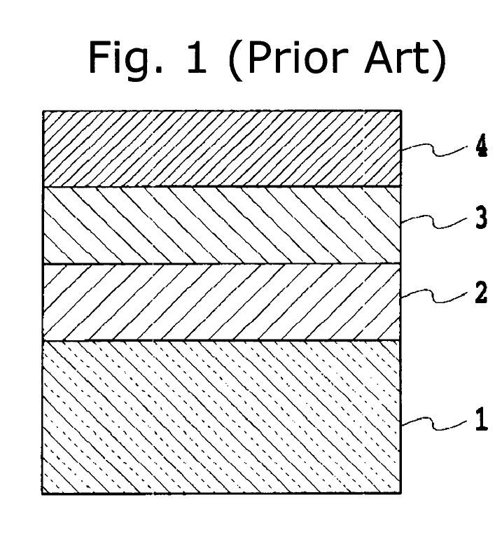

FIG. 2 schematically illustrates an embodiment of a magnetic recording medium according to the present invention.

FIGS. 3A-3B illustrate graphs showing the change in SNR and resolution, which indicates high frequency properties, upon changing Cr—Mn film thickness.

### DETAILED DESCRIPTION

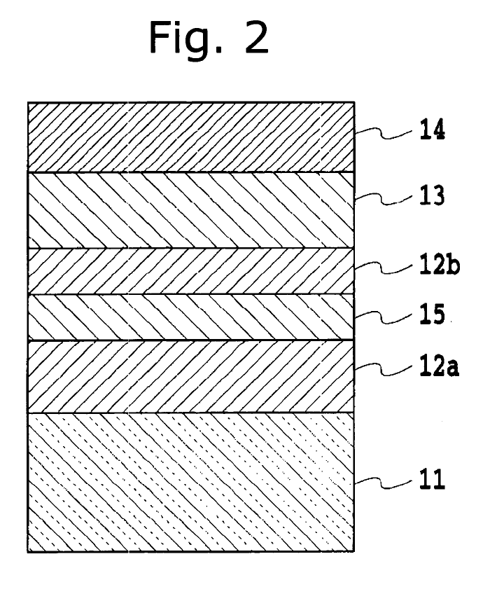

Referring to FIG. 2, which schematically illustrates a cross-sectional of an embodiment of a magnetic recording medium according to the present invention. The present recording medium includes a nonmagnetic substrate 11, a first nonmagnetic underlayer 12a, a second nonmagnetic underlayer 12b, a magnetic recording layer 13, a carbon protective layer 14, and a Cr—Mn layer 15.

The first nonmagnetic underlayer 12a (hereinafter referred to as the ‘first underlayer’), the Cr—Mn layer 15, the second nonmagnetic underlayer 12b (hereinafter referred to as the ‘second underlayer’), the magnetic recording layer 13, which can be made of a Co alloy, and the carbon protective layer 14 are formed in this order, for example, by sputtering (DC magnetron) on the nonmagnetic substrate 11, which can be composed of an aluminum alloy having thereon an Ni—P plating layer that has been given a texture with an average roughness of 0.5 nm in a circumferential direction.

The magnetic recording layer 13 is made of a Co alloy. The underlayers 12a and 12b and the Cr—Mn layer 15 form an underlayer structure. The underlayer structure can be composed of a combination of at least two underlayers 12a, 12b each made of a material selected from pure metals and alloys having a bcc structure, and the Cr—Mn alloy thin film 15 provided between the underlayers 12a and 12b . One of the two underlayers 12a, 12b can be a thin film of pure Cr and the other of the two layers can be a thin film of an alloy of Cr and at least one element selected from Mo, W, V, Ti, B and Ta.

As an example of an embodiment of the present magnetic recording medium, the Co alloy magnetic recording layer 13 was selected to have a composition of Co-18Cr-12Pt-6B (at %), with a uniform thickness of 15 nm. The first underlayer 12a was selected to be composed of pure Cr having a bcc structure and an excellent crystal orientation in the circumferential direction of the nonmagnetic substrate 11, with a uniform thickness of 7 nm. The second underlayer 12b was selected to be composed of Cr-20Mo (at %), which has good crystal lattice spacing conformity with the Co alloy magnetic recording layer 13, with a uniform thickness of 3 nm. The Mn content in the Cr—Mn layer 15 was selected to be 10, 20 or 30 at %. For each of the metallic thin films, it was verified that the composition of the thin film formed was substantially the same as the composition of the target. The nonmagnetic substrate 11 was selected to have a donut shape having an outside diameter of 95 mm and an inside diameter of 25 mm, and the thickness of 1.0 mm. The carbon protective layer 14 was selected to have a thickness of 5 nm. The argon pressure during the sputtering was made to be constant at 5 mTorr. Before sputtering, the substrate was heated such that the temperature of the substrate immediately before the formation of the first underlayer 12a was approximately 250° C.

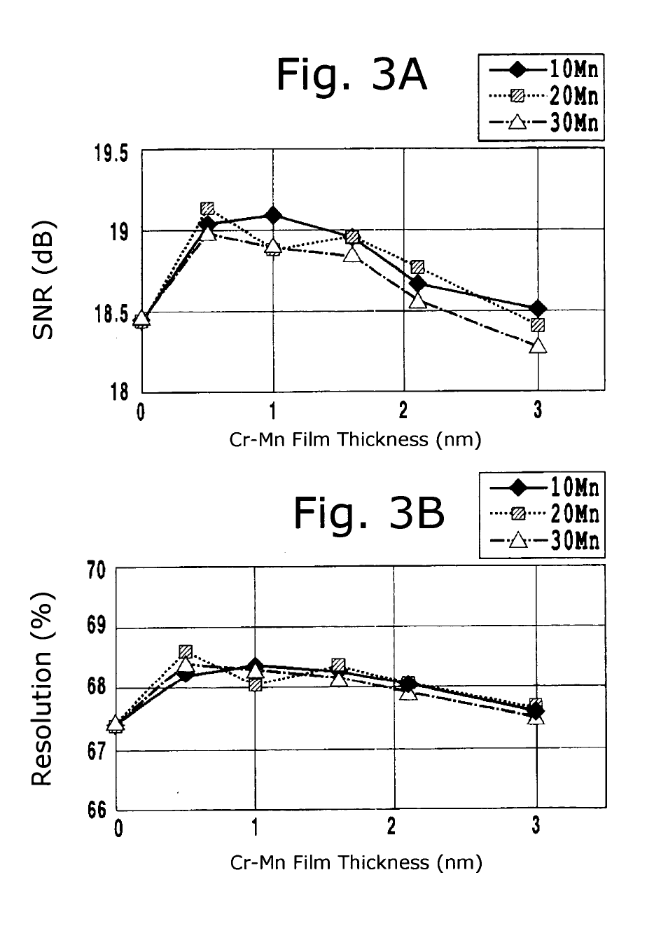

FIGS. 3A-3B illustrate graphs showing the change in SNR and resolution, which indicates high frequency properties, upon changing the Cr—Mn film thickness. A spin stand type R/W tester was used in the measurements. A GMR (giant magnetoresistive) type magnetic head was used for the measurements. The measurement radius was made to be 33 mm, the rotational speed of the substrate 4500 rpm, and the measurement linear recording density 308 kfci.

It was found that by providing a Cr—Mn layer 15 of thickness 0.5 nm, the SNR was improved compared with a conventional magnetic recording medium having no Cr—Mn layer 15 (i.e., thickness of 0 nm). It was also found that the resolution increased, and hence high frequency properties were improved, i.e., the suitability to high-density recording was increased. For all of the Cr—Mn compositions, the SNR then dropped as the thickness of the Cr—Mn layer was increased.

An SNR value higher than with the conventional magnetic recording medium is maintained up to a Cr—Mn layer 15 thickness of 3 nm for the Cr—Mn layer 15 composed of Cr-10Mn or Cr-20Mn, and up to a Cr—Mn layer 15 thickness of 2.5 nm for the Cr—Mn layer 15 composed of Cr-30Mn. Accordingly, the Cr—Mn layer 15 having the thickness of 3 nm or 2.5 nm is the upper limit in the present invention. It is difficult to stably and uniformly form an extremely thin film of thickness 3 nm or less in terms of both physical properties and film thickness. This problem is particularly severe for a film thickness of less than 0.5 nm, and hence a film thickness of less than 0.5 nm is taken to be outside the scope of applicability in the present embodiment. Within the range of 0.5 nm to 3 nm, a higher film thickness is preferable from the viewpoint of productivity; it is preferable to select the Cr—Mn layer 15 film thickness as appropriate in accordance with the required amount of improvement in the SNR. That is, the composition and film thickness of the Cr—Mn layer 15 are preferably an Mn content in the Cr—Mn alloy thin film of not more than 20 at % and a Cr—Mn alloy thin film thickness in a range of 0.5 nm to 3 nm, or an Mn content in the Cr—Mn alloy thin film of not more than 30 at % and a Cr—Mn alloy thin film thickness in a range of 0.5 nm to 2.5 nm.

The limitation of the range of the composition has been carried out with the following considerations. With Cr-30Mn, the range of Cr—Mn film thicknesses that can be used is narrower than in the case of a lower Mn content. If more Mn were added than this, then the range of Cr—Mn film thicknesses that can be used would become yet narrower, and hence the permitted tolerance in the Cr—Mn film thickness during production would be reduced. There is thus an upper limit for the Mn content, and from the results described above, in the present embodiment this upper limit has been set at 30 at %. The crystal structure of Mn is known to be a type of cubic lattice in which a plurality of simple bcc lattices are combined. As Mn is progressively added to bcc crystals of Cr or the like, the bcc lattice thus progressively becomes more disordered. It is thought that the drop in SNR upon adding too much Mn is due to this disordering of the lattice. When the amount of Mn added is small, such disordering of the crystal lattice cannot occur, and hence there is no particular lower limit on the amount of Mn added.

It was found that the activation volume for the magnetic recording medium of the present embodiment having a 1.6 nm layer of Cr-10Mn inserted therein was approximately 12% lower than that for the conventional magnetic recording medium. The activation volume is approximately equal to the crystal grain volume, and hence a lower value of the activation volume indicates that finer crystal grains have been formed. Moreover, from electron diffraction measurement results and so on, no deterioration in the crystallinity or crystal orientation due to the insertion of the Cr—Mn layer was found. From the above, it is thought that the improvement in the SNR upon inserting the Cr—Mn layer is due to reducing the crystal grain size without bringing about deterioration in the crystallinity or crystal orientation.

The present invention provides a fine underlayer structure while maintaining crystallinity. The effects of the underlayer are thus not lost through the layer structure over the underlayer formed. The present invention is thus also effective with new types of magnetic recording medium that have been reported from various sources, for example magnetic recording media in which a Co alloy thin film is inserted between the underlayer and the magnetic recording layer, and recording media in which antiferromagnetic coupling is obtained between two or more magnetic layers via Ru layer(s).

As described above, according to the present invention, the magnetic recording layer is made of a Co alloy, the nonmagnetic underlayers comprise a layered structure of a combination of at least two underlayers each made of a material selected from pure metals and alloys having a bcc structure, and a Cr—Mn alloy thin film provided between the nonmagnetic underlayers. As a result, by making the nonmagnetic underlayers comprise a layered structure comprising a plurality of thin films, and inserting a Cr—Mn alloy thin film having a prescribed composition and thickness within the layered structure, it is possible to reduce the crystal grain size without bringing about deterioration in the crystallinity of the thin film, and hence to improve the SNR.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosure of the priority application, JP 2003-019263 in its entirety, including the drawings, claims, and the specification thereof, is incorporated herein by reference.

What is claimed is:

1. A magnetic recording medium comprising:
a nonmagnetic substrate;
an underlayer structure on the substrate; and
a magnetic recording layer on the underlayer structure,
wherein the magnetic recording layer is composed of a Co alloy,
wherein the underlayer structure comprises a combination of at least two nonmagnetic underlayers each composed of a material selected from pure metals and alloys having a bcc structure, and a Cr—Mn alloy thin film provided between the two nonmagnetic underlayers.

2. The magnetic recording medium according to claim 1, wherein the nonmagnetic underlayers are each composed of pure Cr or a Cr alloy, and the Cr—Mn alloy thin film has an Mn content of not more than 20 at % and a thickness thereof ranging 0.5 nm to 3 nm.

3. The magnetic recording medium according to claim 1, wherein the nonmagnetic underlayers are each composed of pure Cr or a Cr alloy, and the Cr—Mn alloy thin film has an Mn content of not more than 30 at % and a thickness thereof ranging 0.5 nm to 2.5 nm.

4. The magnetic recording medium according to claim 2, wherein one of the two underlayers is composed of pure Cr and the other of the two underlayers is composed of an alloy of Cr and at least one element selected from Mo, W, V, Ti, B and Ta.

5. The magnetic recording medium according to claim 3, wherein one of the two underlayers is composed of pure Cr and the other of the two underlayers is composed of an alloy of Cr and at least one element selected from Mo, W, V, Ti, B and Ta.

6. The magnetic recording medium according to claim 4, wherein the other of the two underlayers is composed of an alloy of Cr and Mo.

7. The magnetic recording medium according to claim 5, wherein the other of the two underlayers is composed of an alloy of Cr and Mo.

8. The magnetic recording medium according to claim 1, wherein the nonmagnetic substrate is composed of an aluminum alloy having thereon an Ni—P plating layer.

9. The magnetic recording medium according to claim 8, wherein the Ni—P plating layer that has a texture with an average roughness of 0.5 nm in a circumferential direction of the substrate.

10. The magnetic recording medium according to claim 1, further including a protective layer on the magnetic recording layer.

11. An underlayer structure for a magnetic recording medium, comprising:
at least two nonmagnetic underlayers each composed of a material selected from pure metals and alloys having a bcc structure; and
a Cr—Mn alloy thin film provided between the two nonmagnetic underlayers.

12. The underlayer structure according to claim 11, wherein the nonmagnetic underlayers are each composed of pure Cr or a Cr alloy, and the Cr—Mn alloy thin film has an Mn content of not more than 20 at % and a thickness thereof ranging 0.5 nm to 3 nm.

13. The underlayer structure according to claim 11, wherein the nonmagnetic underlayers are each composed of pure Cr or a Cr alloy, and the Cr—Mn alloy thin film has an Mn content of not more than 30 at % and a thickness thereof ranging 0.5 nm to 2.5 nm.

14. The underlayer structure according to claim 12, wherein one of the two underlayers is composed of pure Cr and the other of the two underlayers is composed of an alloy of Cr and at least one element selected from Mo, W, V, Ti, B and Ta.

15. The underlayer structure according to claim 13, wherein one of the two underlayers is composed of pure Cr and the other of the two underlayers is composed of an alloy of Cr and at least one element selected from Mo, W, V, Ti, B and Ta.

16. The underlayer structure according to claim 14, wherein the other of the two underlayers is composed of an alloy of Cr and Mo.

17. The underlayer structure according to claim 15, wherein the other of the two underlayers is composed of an alloy of Cr and Mo.

18. A method of forming a magnetic recording medium comprising the steps of:
providing a nonmagnetic substrate;
forming an underlayer structure on the substrate; and
forming a magnetic recording layer on the underlayer structure,
wherein magnetic recording layer is composed of a Co alloy,
wherein the underlayer structure comprises a combination of at least two nonmagnetic underlayers each composed of a material selected from pure metals and alloys having a bcc structure, and a Cr—Mn alloy thin film provided between the two nonmagnetic underlayers.

19. The method according to claim 18, wherein the nonmagnetic underlayers are each composed of pure Cr or a Cr alloy, and the Cr—Mn alloy thin film has an Mn content of not more than 20 at % and a thickness thereof ranging 0.5 nm to 3 nm.

20. The method according to claim 18, wherein the nonmagnetic underlayers are each composed of pure Cr or a Cr alloy, and the Cr—Mn alloy thin film has an Mn content of not more than 30 at % and a thickness thereof ranging 0.5 nm to 2.5 nm.

21. The method according to claim 19, wherein one of the two underlayers is composed of pure Cr and the other of the two underlayers is composed of an alloy of Cr and at least one element selected from Mo, W, V, Ti, B and Ta.

22. The method according to claim 20, wherein one of the two underlayers is composed of pure Cr and the other of the two underlayers is composed of an alloy of Cr and at least one element selected from Mo, W, V, Ti, B and Ta.

23. The method according to claim 21, wherein the other of the two underlayers is composed of an alloy of Cr and Mo.

24. The method according to claim 22, wherein the other of the two underlayers is composed of an alloy of Cr and Mo.
